(19) United States
(12) Patent Application Publication
(10) Pub. No.: US 2006/0144781 A1
(43) Pub. Date: Jul. 6, 2006

(54) Water purification system

(75) Inventors: Eric V. Carlson, Lake Oswego, OR (US); John Michael O'Brien, Tualatin, OR (US); Daniel S. Peterson, Tualatin, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Global Water, LLC

(21) Appl. No.: 11/029,962

(22) Filed: Jan. 4, 2005

(51) Int. Cl. B01D 24/00

(52) U.S. Cl. 210/459; 210/464; 210/473; 210/470; 210/321.6

(57) ABSTRACT

A system for providing purified drinking water for populations and persons having minimal access to modern water purification systems and therefore rely on water sources which contain microorganisms known to cause illness and death to large segments of such populations. Membranes are known which are pervious to water and impervious to the contaminants in such drinking water. The invention provides for gravity flow passage of water from the dirty (contaminated) water containment area to a clean (purified) water containment area and a filter including such a membrane whereby the flow of water has to penetrate through the membrane and in the process filters out the illness-producing microorganisms. The invention enables the use of commonly available jugs or jars requiring only a gravity flow passage between the jugs or jars and the filter contained in the passage.

### FIELD OF INVENTION

This invention relates to the purification of water in a manner that renders it feasible to provide drinking water for populated regions where available water sources are largely unsuitable for drinking.

### BACKGROUND OF THE INVENTION

It is known that regions of poverty exist throughout the world and that within such regions there is a high percentage of illness and deaths resulting from ingestion of water having impurities in the form of microorganisms.

Whereas water purification techniques and systems are known, none are deemed feasible for these regions due to cost and complexity. To alleviate the above identified problem it is believed that a water purification system needs to be available on an individual basis with low cost, simplicity and convenience a necessity. Whereas membrane materials are available to filter out the impurities of illness-producing microorganisms, no one has heretofore incorporated such membrane into a simple but effective system such as to enable an individual or a small number of individuals, e.g. of a family, to generate, for their own consumption, drinkable water from undrinkable water sources. That is an objective of the present invention.

### BRIEF DESCRIPTION OF THE INVENTION

The present invention, in a preferred embodiment, utilizes a pair of liquid containers, e.g. jugs, jars or water bottles each having an open mouth and which accommodate common covers or lids to seal the interior of the container. A single cover includes opposing sides, one side fitting the mouth of one container and the opposite fitting the mouth of the other, e.g., via screw threads. A membrane is seated and sealed inside the cover (between the opposing sides) so that liquid can only pass between the two containers by passing through the cover and thus through the membrane.

One of the containers is designated as the dirty water container and the other the pure water container. With the cover separated from the dirty water container, the dirty water container is filled with dirty water, e.g. taken from a stream, pool, lake or other unsuitable water source. The corresponding cover side is refitted to the dirty water container. The empty pure water container is inverted and fitted to the opposing side, i.e. to the top side of the cover, and the two-tier container structure is inverted so that the dirty water of the top container, via the force of gravity, is filtered down through the cover and through the membrane in the cover and into the clear water container, the impurities being entrapped by the membrane.

Whereas the above is but one example or embodiment of the invention, there are many variations that will be apparent to those skilled in the art, several of which are illustrated in the drawings appended hereto.

### BRIEF DESCRIPTION OF THE DRAWINGS

FIG. 1 is an exploded, perspective view of an embodiment of the invention;

FIG. 2 is a top view of one of the components of the embodiment of FIG. 1 as viewed on view lines 2-2;

FIG. 3 is a section view as seen from section lines 3-3 of FIG. 2;

FIG. 4 is a bottom view of a component of FIG. 2 as seen on view lines 4-4 of FIG. 1;

FIGS. 5-7 are alternate embodiments of the invention; and

FIGS. 8 and 9 are alternate versions of the embodiment of FIGS. 1-4.

### DETAILED DESCRIPTION OF THE INVENTION

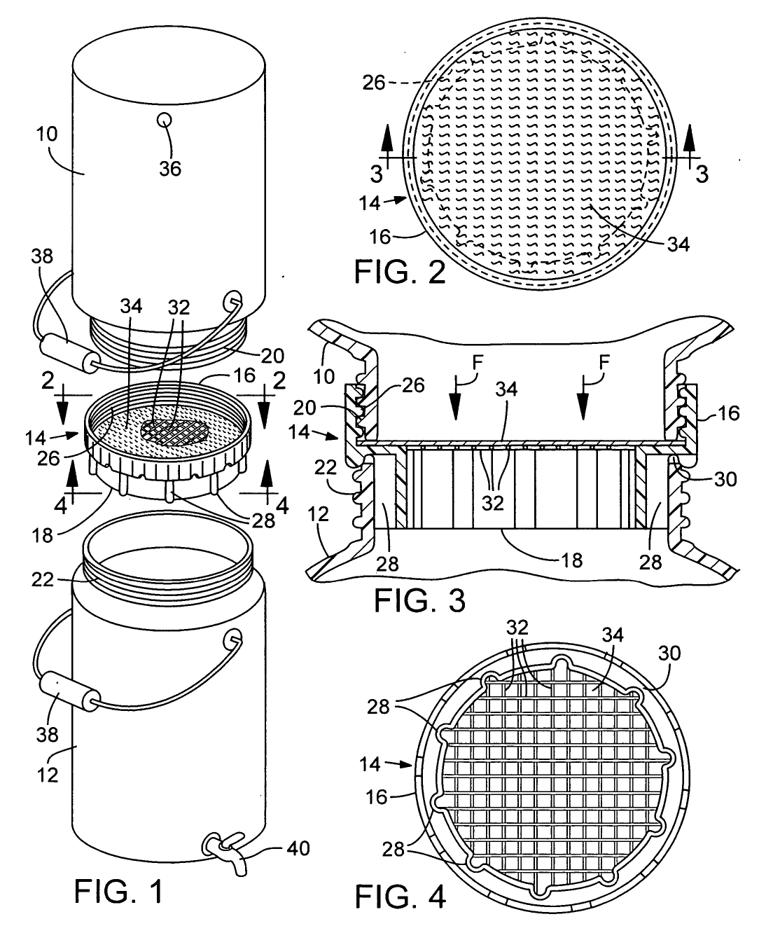

Reference is made to FIG. 1 which illustrates an embodiment of the invention in exploded view. An inverted dirty water container 10 is suspended over an upright clean water container 12. An intermediate cover/filter 14 includes a threaded portion 16 which mates with threads 20 circumscribing the mouth of container 10. The cover/filter 14 further has a circular projecting lip 18 opposite threaded portion 16 that nests inside the mouth 22 of the clean water container 12.

The cover/filter 14 is illustrated in more detail in FIGS. 2, 3 and 4 (see view lines 2-2 and 4-4 of FIG. 1 and view lines 3-3 of FIG. 2). As shown, there is a threaded portion 16 and an insertable lip portion 18. The threaded portion 16 contains internal screw threads 26 that mate with screw threads 20 of container 10. The lip portion 18 is sized slightly smaller than the inner diameter of the mouth 22 of container 12 (see FIG. 1) but has vent tabs 28 that provide a friction fit to container 12 but allowing space in between the tabs to vent air as will be later discussed.

A peripheral shelf 30 is formed between the upper and lower portions of the cover. A molded support grid 32 at the shelf level spans the opening defined by the shelf 30 as shown, particularly in FIG. 4. A thermally bondable microporous hydrophilic membrane 34 is fitted to the opening and extended over the peripheral shelf. The portion overlying the shelf is thermally bonded to the shelf with the intermediate non-bonded central portion of the membrane supported on the grid 32 (see FIG. 3).

The membrane, except for its porosity, totally separates the upper and lower portions of the cover 14. As illustrated in FIG. 3, the threads 26 of the upper portion are screwed onto the threads 20 of container 10 whereby no liquid from container 10 can leave container 10 without passing through the membrane 34. The weight of the liquid in container 10 in pressing down on the membrane 30 is supported by the support grid 32. Thus, gravity generates a force F to cause the liquid in container 10 to pass through membrane 34 as permitted by the porosity of the membrane. With reference to FIG. 1, an anchor-type plug is removed from opening 36 to allow air into the top of the container. As water seeps through the membrane 34 and begins to fill the container 12, air is vented from container 12 due to the spaces between tabs 28.

Operation

In operation, it will be appreciated that the container 10 can be a very simple plastic jug of desired proportion and may be fitted with a wire handle indicated at 38. An individual simply lifts container 10 and cover 14 off container 12, unscrews cover 14 and preferably places it back into mouth 22 of container 12 to ensure continued purity of the water therein. The individual then goes to the water source, e.g., a creek or pond, fills the container 10 and returns to the location of container 12. He reverses the process just described, i.e., he removes the cover from container 12, screws it onto the threads 20 of container 10 and then inverts the container 10 for reseating lip portion 18 of the cover 14 into the mouth 22 of container 12.

Water from container 12 can be ingested free of microorganisms which have been removed by the filter, i.e., membrane 34. The water of container 12 is accessible in many ways, e.g., by the inclusion of a spigot 40 into container 12.

Whereas there are many variations available, the primary need is to provide a system that does not require sophisticated or complex purification processes. The needs are

(a) a container for containing/collecting unpure/dirty water (container 10);

(b) a container for receiving/storing clean water (container 12);

(c) a gravity flow passage between the content of items (a) and (b); and

(d) the insertion of a contaminant-removing filter in said passageway.

The filter itself is preferably a sheet or membrane that is microporous and hydrophilic. Also, to ensure a secure bond, e.g. to shelf 30, it is desirable that the membrane be thermally bondable. The membrane filters out the microorganisms known to reside in water supplies and which microorganisms are most prevalent in the causation of illnesses. A suitable membrane for this purpose is obtainable from Oxphenag.

Whereas the illustrated embodiment is but one of many systems that satisfy the objective of this invention as recited above, the following are but a few examples of such variations.

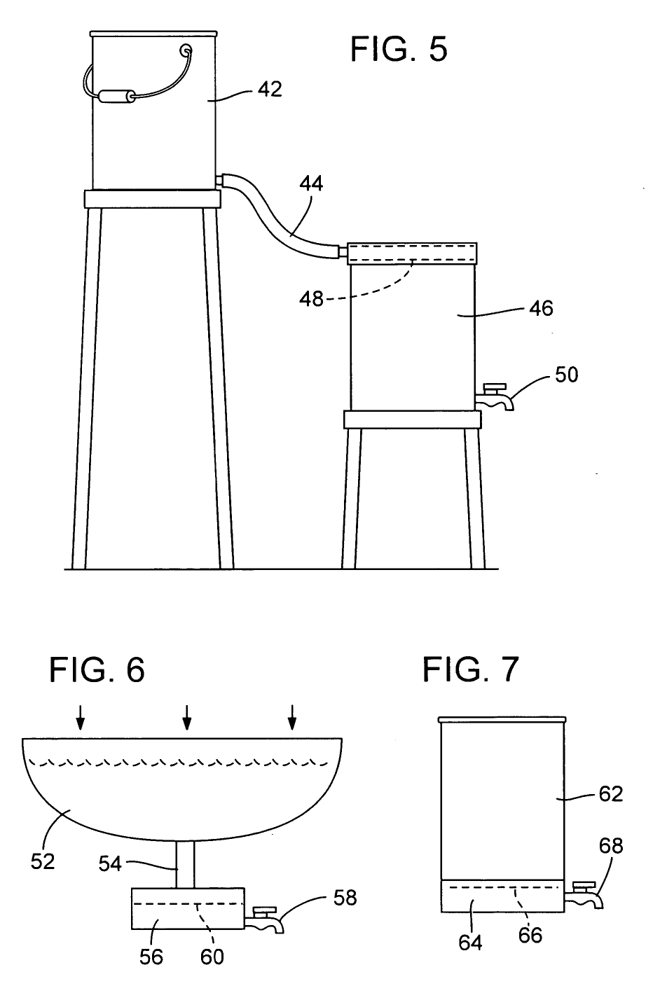

FIG. 5 is a bucket 42 of dirty water that can be placed on a shelf or hung on a hook with a hose 44 connected to a dispensing container 46 wherein a filter/membrane 48 divides the container 46 into upper and lower chambers requiring filtration of the water before it can be dispensed from spigot 50.

FIG. 6 illustrates an open bowl 52, e.g., for collecting rain water or the like, again with a hose 54 directing the collected water through a filter 60 and into a container 56 for dispensing from a spigot 50.

FIG. 7 is intended to illustrate a small community type container, e.g., for a family of persons. A large open-top tank 62, e.g. a 20-gallon container, includes a bottom portion 64 that is separated from the top portion by a filter 66. It is envisioned that the small community could cooperatively fill tank 60 from smaller buckets and then receive filtered water, e.g., from one or several spigots 68.

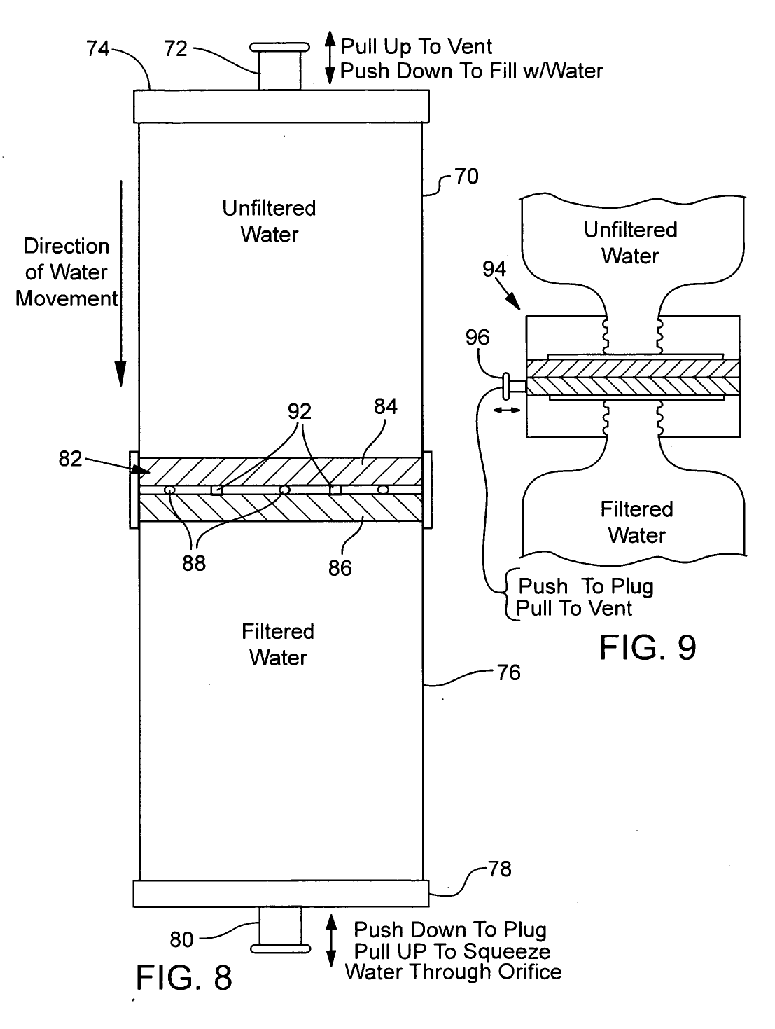

FIG. 8 is a system similar to that of FIGS. 1-4 but wherein the containers are more similar to the common water bottle as may be found in households, offices, etc. The top water bottle 70 (as viewed in FIG. 8) includes an upper vent valve 72 mounted in a top cover 74 (cover 74 may be permanently affixed to the top of the bottle or screw fit to the top of the bottle). The bottom water bottle 76 includes a bottom cover 78 similar to that of cover 74 but which cover is fitted with a dispensing valve 80.

The top water bottle 70 has a bottom mouth and the bottom water bottle 76 has an upper mouth, both provided with screw threads that mate with upper and lower screw threaded portions 84, 86 of filter member 82. Member 82 is fitted with a membrane 34 and support grid 32 in a manner consistent with the version of FIGS. 1-4.

Whereas theoretically purified water from container 76 can be drawn through valve 80 while the water is filtered down through the membrane 82 from bottle 70 (which bottle 70 is vented via valve 70), it is deemed preferable to provide cover 82 with a vent ring 90. Vent ring 90 includes vent holes 88 and allows the user to open and close the vent holes as needed to assure optimum flow of purified water through valve 80.

Alternatively, the filter member can be replaced with a member 74 as illustrated in FIG. 9 which replaces the vent ring with a simple push pull vent valve 96.

Whereas a number of embodiments have been disclosed, these are but examples and it is anticipated that others skilled in the art will conceive of numerous variations without departing from the scope of the invention as defined in the claims appended hereto. The terms used in the claims are intended to be interpreted as broadly understood in the art.

What is claimed is:

1. A drinking water purification system comprising:
a first container for containing water considered unsuitable for drinking;
a second container placed at a lower elevation than said first container, and a passageway from said first container to said second container;
a filter mounted in said passageway such that gravity flow of water is prevented from flowing from the first container to the second container except by passing through the filter, and said filter being a hydrophilic microporous membrane that is pervious to water and impervious to health contaminant microorganisms contained in the water of said first container.

2. A drinking water purification system as defined in claim 1 wherein said first and second containers are common jug, jar or water bottle type containers having upper mouths for receiving and dispensing liquid, and a cover and filter combination having one side adapted to fit the mouth of one bucket and an opposite side adapted to fit the mouth of the other container, and said filter residing between said sides whereby with the cover fitted to both containers and the first container containing dirty water inverted over the second container, water passes through the filter and into the second container in a purified form.

3. A drinking water purification system as defined in claim I wherein the first container has a closable bottom opening, the second container is substantially permanently sited with a lid containing the filter, a suspension holder for releasably holding the first container suspended above the second container, and a hose providing passage between said closable bottom opening and said cover for passage of water to the cover and through the filter and into the second container.

4. A drinking water purification system as defined in claim I wherein the first container is a substantially permanently sited container for receiving and containing contaminated water, a hose for directing gravity flow of water to a holding tank, said holding tank separated into upper and lower compartments, and said filter separating said upper and lower compartments, said lower compartment having an outlet for dispensing filtered water.
